(19) United States
(12) Patent Application Publication
(10) Pub. No.: US 2012/0089565 A1
(43) Pub. Date: Apr. 12, 2012

(54) Systems and Methods for Network-based Communication, Collaboration, and Documentation System

(76) Inventor: John D. Jackson, Henderson, NV (US)

(21) Appl. No.: 12/899,146

(22) Filed: Oct. 6, 2010

(51) Int. Cl. G06F 17/30; H04L 9/32; G06F 7/00

(52) U.S. Cl. 707/608; 726/5; 707/781; 707/E17.005; 707/E17.032

(57) ABSTRACT

System and methods for the creation, organization, and retrieval of the categorized forms of communication between users and organizations based on relationships between projects. Any two users can establish a database link from one user's project database to another user's project database through an invitation and acceptance process. Once linked, a variety of communication types can be provided to the linked project databases, and each type of communication can have an associated set of workflow rules for managing how the communication is routed. The systems and methods disclosed herein can facilitate communications both inter-organizational and intra-organizational communications through the use of linked project databases.

### FIELD OF THE INVENTION

The present invention generally relates to the field of project management and more specifically to systems and methods for coordinating multiple-users projects.

### BACKGROUND

Conventional project management systems allow users to create, store, and retrieve communications and documents for managing projects. Such systems are often used to manage complex projects, coordinate the actions of multiple parties, and project deadlines. Conventional project management system can allow users to track documentation and various types of communications, but these project management systems are typically effectively for managing projects internally within an organization, while many complex projects can include input from a number of participants from multiple organizations.

Some conventional project management systems can allow users to communicate with one another over a network in order to share information, but the type of information that can be shared and the connections between the users, is often limited. Often, each user will have separate project management software and databases for managing the parts of the project for which the user is responsible. While some conventional systems may allow for users to communicate project information to one another, these separate user databases are typically not connected to one another. As a result, users must often manually enter project information into their own database when communicating with another organization. For example, a user receives an email regarding a specific project: The email is from another user that is outside of their organization and thus, outside of their organization's project management database. In order to log the communication into the project management database, the user may have to manually enter any information received in the email into the project database. This can also negatively impact project workflow. For example, if an action item or approval needs to be sent from one organization to another and each organization maintains separate project management systems; there is no provision for coordinating the workflow outside of the organization. Once the request or action item leaves the organization, there is no way for the system to track the progress of the communication in the forwarding and/or approval process.

Some conventional systems allow other organizations to log into one common database where common logs and files are managed through filtering to control access, provide security and utilize workflow. There are common features of these systems. One feature is a single system and database administrator, usually a party of the project organization setting up the common database. This administrator provides access to external organizations for a single project through a login feature. Once that administrator excludes access to a user, that user has no access to the project database. Another feature: these systems still require double entry. If a user, who has been given access to a external project database through a login feature, is still maintaining internal project databases—even if using the same software—the record of information has to be re-entered into the internal project database system.

### SUMMARY

System and methods for the creation, organization, and retrieval of the categorized forms of communication between users and organizations based on relationships between projects. Any two users can establish a database link from one user's project database to another user's project database through an invitation and acceptance process. Once linked, a variety of communication types can be provided to the linked project databases, and each type of communication can have an associated set of workflow rules for managing how the communication is routed. The systems and methods disclosed herein can facilitate communications both inter-organizational and intra-organizational communications through the use of linked project databases.

According to one embodiment, a technical system for managing projects is provided. The system includes a non-transitory computer readable medium for storing computer executable programmed modules, and a processor communicatively coupled with the non-transitory computer readable medium for executing programmed modules stored therein. The system also includes a workflow module that is stored in the non-transitory computer readable medium and is configured to manage a plurality of user databases and project databases, create links between user databases and project databases, wherein if a user database is linked to a project database, a user associated with the project database can access content in the database, create links between project databases, and manage communications between projects based on workflow rules, wherein copies of communications between users associated with each of the projects are copied to each linked database where communications are drafted between users linked to different project databases.

According to another embodiment, a computer implemented method for managing projects is provided where one or more processors are programmed to perform the steps of the method. The method includes the steps of: receiving a request from a first user to send an invitation to a second user to link the second user to a first project having a first project database, sending the invitation to the second user, receiving a response from the second user indicating whether the second user accepts the invitation, and creating a link between the second user and the first project if the second user accepts the invitation, wherein the link allows the second user to access content in the first project database.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of a network-based communication, collaboration, and documentation system according to an embodiment;

FIG. 2 is block diagram of the logical components of a server that can be used to implement the server illustrated in FIG. 1 according to an embodiment

FIGS. 3-7 are block diagrams of data storage areas that can be used with the system illustrated in FIGS. 1 and 2 and logical links between these storage areas according to an embodiment;

FIG. 8 is a flow diagram of a method for creating a user database and a project database according to an embodiment;

FIG. 9 is a flow diagram of a method for authenticating a user who has an existing account and for creating a new project associated with a user according to an embodiment;

FIG. 10 illustrates a method for authenticating a user to access and update a project according to an embodiment;

FIG. 11 is a flow diagram of a method for sending an invitation from a first user linked to a project database to a second user linked to a separate project database, to establish a link between the two project databases.

FIG. 12 is a flow diagram of a method for sending an invitation from a first user linked to a project database to a second user to establish a link between the second user and the same project database according to an embodiment;

FIG. 13 is block diagram illustrating a method for indirectly sending a communication from a first user to a second user via an intermediate third user according to an embodiment;

FIG. 14 is a block diagram of a computer system that can be used to implement the user devices of FIG. 1 of the server illustrated in FIGS. 1 and 2 according to an embodiment; and

FIG. 15 is a block diagram of an exemplary wireless device that can be used to implement the user devices of FIG. 1 of the server illustrated in FIGS. 1 and 2 according to an embodiment

### DETAILED DESCRIPTION

Embodiments of the present invention provide systems and method for the creation, organization, and retrieval of the categorized forms of communication between users and organizations based on relationships. A variety of communication types can be provided, and each type of communication can have an associated set of workflow rules for managing how the communication is handled. The systems and methods disclosed herein can facilitate communications between users contributing to a project both within an organization and between users in different organizations that are contributing to the project. Communications can flow seamlessly between users and organizations and the system can provide an authenticated chain of custody that can be used to track the status of communications. All communications and documentation associated with projects can be stored in project databases. The information stored in the project databases can be electronically time stamped, and the status of the project overall, as well as the status of specific action items can be viewed on demand.

Studies show that the major causes of project delays are related to failures in communication. As an example, the most common construction delay results from a delay in procurement of construction materials either from delays in approval of materials, or delays in resolution of conflicts. Embodiments of the systems and methods disclosed herein can maximize the efficiency of projects by communicating, tracking, and documenting issues to avoid communication delays and disconnects and to improve organizational efficiency. This efficiency can be achieved by providing for centralized and organized management of communications based on relationship types of the parties to the communication.

For example, a significant drawback of conventional communication and document control systems is that each party keeps their own system that can be inefficient since no direct communication is available between similar systems, can require double entry of data that is sent between organizations, is contingent on the weakest system in the communication links (where projects span organizations, the organizations may have disparate project management systems with very different functionality), and does not have the ability to track end-to-end progress of tasks and/or communications. Some conventional systems can be extremely paper intensive, which can result in lost information or information that is not easily shared between parties working on a project. Conventional systems also do not include standard communications categories that can be used across organizations. For example, one organization might categories communications using a first set of categories, while a second organization may categorize communications using a second set of categories. This can result in miscommunication between the two organizations if the categories of communications are not properly mapped. Intra-organizational communication processes are also not standardized in many conventional systems.

### Communications Management

One aspect of the systems and methods described herein is a set of tools that facilitate communications. In an embodiment, the communications tools include several categories of communications that can be used for business-to-business and project-to-project communications. These communications types includes:

(1) Memorandums: memorandums can be sent by a user to one or more users linked to the specific project database. Memorandums are informational and do not require a response from the recipients. According to an embodiment, a copy of a memorandum can be stored in the project database of the sender and each of the recipients.

(2) Transmittals: this category of communication can be used to provide notice that some object or document is being forwarded to a user for review. Transmittals can be associated with workflow rules that control the distribution of the transmittal and the documents or objects being sent for review. For example, in an embodiment, a transmittal can have one or more rules associated with the transmittal that can be used to determine to whom the transmittal should be routed, whether the transmittal requires a response, and to whom the response should be directed.

(3) Information Request: this category of communication requires, or at least expects an answer, or some form of direction from one or more recipients. In an example, a lighting contractor can post an information request to the general contractor for a project, asking the general contractor for clarification of conflicting details in the drawings regarding installation of fixtures. In another example, a general contractor might post a request for a proposal to the lighting contractor asking the lighting contractor for a cost proposal for installing additional light fixtures. In yet another example, an events coordinator for a wedding can send an information request to one or more vendors requesting a price quote for china for the reception.

(4) Submittal for Approval: this category of communication includes tracking the submission of an item for approval. Returning to example described above, a lighting contractor can send the general contractor a submittal requesting approval of a set of lighting fixtures for a project. In another example, a florist could send a submittal for approval for floral arrangement designs for a wedding to a wedding coordinator, and the wedding coordinator could forward the submittal to the parties being married for approval. In another example, a general contract may send a request for submittal to a subcontractor requesting the subcontractor to submit a product sample for approval before procurement is finalized.

(5) Action Items, or Task Manager: this category includes tasks or items that require action. In an embodiment, action items may have a due date or requested completion date by which the task must be completed. The system can provide workflow for action items that allows for notifying one party that an assigned task has been started or completed. Items can also be tracked with start and finish dates. Tasks can be linked to other tasks in linked project databases so that status can be communicated between linked project databases.

(6) Discussions or Meeting notes: this category of communication can be used to document discussions on various topics. These items do not require action to be taken and serve as a record of meetings or discussions by topic related to a project.

### Relationship Management

Another aspect of the systems and methods disclosed herein are relationship management tools that can be used to manage the relationships between parties contributing to a project. In an embodiment, the communications tools can be configured to manage relationships between projects and parties to the projects. These types of relationships that can be managed include:

(1) Vertical relationships: (also referred to herein as “inter-project relationships”) a vertical relationship is a relationship where one party provides approval, direction, and final acceptance, while the other party provides products and services. Some example of vertical relationship include: a buyer/vendor relationship, a manager/direct report relationship, an owner/contractor relationship, a contractor/subcontractor relationship, and a professional/client relationship. In a vertical relationship, each party typically is linked to their own project database in which a copy of all correspondence, documentation, and other information for the project is maintained, but the projects are linked to facilitate communications and sharing of information between the projects. For example, in a buyer/vendor relationship, buyer can have his own project database and the seller can have her own project database linked to the buyers project database. The buyer and seller can store and update information related to the project in their own project databases and at the same time communicate directly to another user by the link connecting the project databases. The links connecting the databases can facilitate workflow automated by the system and so that any communications between the parties automatically updates both project databases avoiding the need for double entry of information when correspondence is sent between the buyer and seller.

(2) Team relationships: (also referred to herein as “intra-project relationships”) a team relationship exists where users can log into the same project database, communicate and manage tasks and events in that project. In this scenario, one user may act on behalf of another in the communication process with another project. Some examples of team relationships include: an executive/admin assistant relationship, a project manager/project team member relationship. In a team relationship, the users typically are linked to the same project database and can view, add, or modify information in the database. In an embodiment, the level of access afforded to each member of team can be configurable. For example, some team members may be able to read content in the database, but not delete or modify the content.

Embodiments combine the flexible communications and project relationship management to maximize the efficiency of project communications.

### Example Embodiments

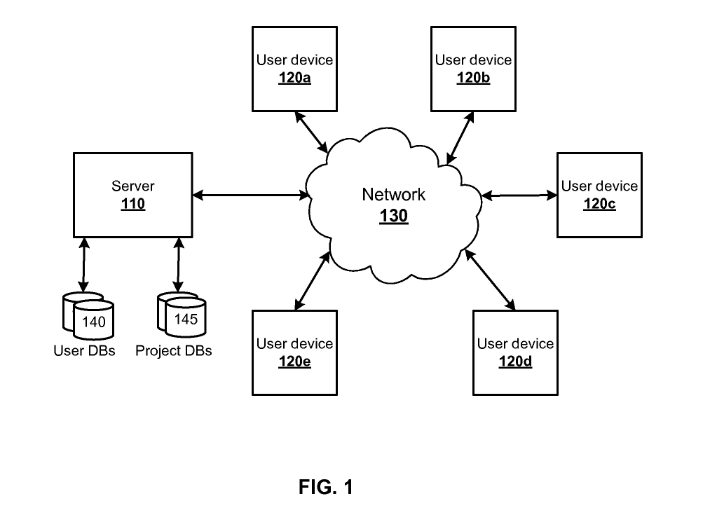

FIG. 1 is a block diagram of a network-based communication, collaboration, and documentation system (also referred to herein as a project management system) according to an embodiment. The system includes a management server 110 that is in communication with a plurality of user devices 120a-120e via a network 130. The user devices 120a-120e can also be any sort of processor enabled computing device capable of communicating wired or wirelessly over the network 130, for example a personal computer, personal digital assistant (“PDA”), telephone, workstation, or the like.

In an embodiment, the server 110 includes a set of compiled or scripted software modules that can be executed on various programmable computer platforms. Server 110 communicates with the user devices 120a-120e over the network 130. In one embodiment, server 110 is implemented as a set of software applications or modules stored in a computer-readable memory of a computer system. These software applications or modules, when executed by the processor of the computer system perform the various functions of the controller 110 described herein.

Network 130 can be a wired network, wireless network, or a combination of homogeneous or heterogeneous networks including both wired and wireless network segments. Network 130 can be a personal area network (“PAN”), local area network (“LAN”), or a wide area network (“WAN”), a private network, public network, or a combination of networks collectively comprising a global communications network such as the Internet. Network 130 can be an ad hoc network or a persistent network and can be fixed in location, mobile, or may comprise a combination of fixed and mobile components. Additionally, network 130 may carry communications corresponding to a single network protocol or to multiple network protocols such as 802.11, 802.15, 802.16, and TCP/IP, just to name a few.

According to an embodiment, server 110 can be configured to manage a plurality of projects, and to create a project database 145 for each project. Various data associated with the project can be stored in the project database 145, such as project-related communications, access permissions indicating which users should have access to the project and authentication information, and documentation related to the project. The server 110 can also be configured to associate one or more users with a project.

According to an embodiment, server 110 can be configured to manage a plurality of users, and to create a user database 140 for each user. The user databases 140 can be used to store data for a particular user. For example, the user database 140 can be used to store authentication information for the user (e.g., login credentials for accessing the project managements), a list of projects to which the user is linked, a user log that keeps track of all of the user's activity with respect to one or more projects, and/or other information related to the user.

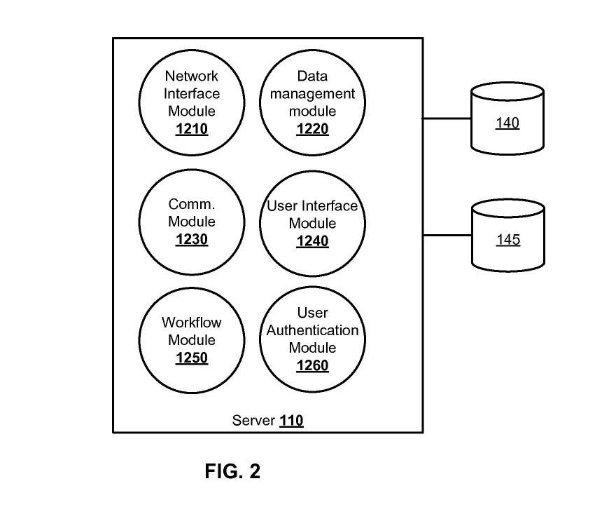

FIG. 2 is a block diagram illustrating the logical components of server 110 according to an embodiment. Server 110 includes a network interface module 1210, a data management module 1220, a communications module 1230, a user interface module 1240, a workflow module 1250, and a user authentication module 1260.

Network interface module 1210 provides an interface for receiving data from network 130 and for sending data across network 130. Network interface module 1210 can be configured to receive data from network 130 and to provide the data to one more of the other modules of the server 110. The network interface module 1210 can be configured to format the data received from the network 130 into a format that is expected by a module of server 110 that is to receive the data. In an embodiment, network interface module 1210 can be configured to format data received from other modules of the server 110 for transmission across the network 130.

Data management module 1220 is configured to provide an interface to server 110 for retrieving data from and storing data to data stores, such as user databases 140 and project databases 145. The data management module 1220 can receive requests to access data from or store data to user databases 140 and project databases 145 or other data stores from the other modules of server 110. The data management module 110 can format the requests into a format that can be understood by the databases or data stores. For example, if user databases 140 and project databases 145 are relational databases, data management module 1120 can convert a request received from a module of server 110 to a query, such as a Structured Query Language (“SQL”) query. The data management module 1220 can also receive data from the user databases 140 and project databases 145 or other data store and convert the data to a format expected by the module requesting the data.

Communications module 1230 can be configured to allow users to initiate communications with other users, to forward communications from one user to another user, and to update the user databases 140 of each party to a communication and to update the project databases 145 of each project for which communications are send or received. In an embodiment, communications can be associated with workflow rules that route the communications through the system based on the workflow rules and/or recipients designated by the sender of the communication. The workflow module 1250 can be configured to handle the routing of communications based on the rules.

User interface module 1240 can be configured to provide a user interface, such as a web page or web pages, for the user devices 120 to interact with the server 110 to use the systems and methods disclosed herein. For example, in an embodiment, the user interface module 1240 can be configured to generate web pages that can be displayed in a browser program being executed on a user device 120. The user interface module 1240 can be configured to generate the dashboard interface described above that can be used to create new project, manage existing projects, draft communications and review incoming communications, generate or upload document, and other project-related tasks. The user interface module 1240 can communicate with the data management module 1220 to request data to be displayed to a user of a user device 120 and to store data entered by users. The user interface module 1240 can also provide a login user interface in which a user can enter login credentials to be authenticated by the server 110 in order to access the system.

Workflow module 1250 can be configured to control the workflow for a project. The workflow module 1250 can be configured to link user databases to project databases, and to link project databases to other project databases. The workflow module 1250 can establish these links in response to user requests. For example, a user can send an invitation to another user to establish a vertical or team relationship and the workflow module 1250 can be configured to create links between the databases and/or create new project databases if necessary (e.g., if new vertical relationship being created with user that does not already have a project database).

The workflow module 1250 can be configured to route communications between users and projects. In some embodiments, a project can include a set of default workflow rules for routing each type of communication through the system, and a user drafting a communication can select the recipients and configure other workflow related options such as a target complete date for a task. In an embodiment, a user creating a project or other authorized users granted administrative access to a project can customize workflow rules. In an embodiment, the user interface module 1240 can provide a user interface that allows a user to view, add, modify, or delete workflow rules. In an embodiment, the workflow rules associated with the project can be stored in the project database 145 associated with the project. For linked projects, workflow rules can be shared across the projects to provide consistent workflow processing across the linked projects.

According to an embodiment, the workflow module 1250 can also be configured to verify that a user is authorized to perform one or more requested actions on project content. For example, if a user attempts to edit or delete content, the workflow manager can make a determination whether the user is authorized to perform the action based on an authorization level associated with the user. In an embodiment, a project database administrator can associate an authorization level with each user invited to access the same project database. Based on this authorization level, the project database manager can determine whether the user is authorized to perform the requested action. For example, some users may be authorized to view content associated with a project database but not to modify existing content. According to an embodiment, the authorization level associated with a user can be stored in the project database 145. A user can also have different authorization levels associated with that user for different project databases.

User authentication module 1260 is in communication with the users interface module 1240 and can receive login credentials provided by a user via the login interface provided by the user interface module 1240. The user interface module can provide login credentials received from a user and the user authentication module 1260 can authenticate the credentials can access the user database 140 associated with the username provided by the user and compare the password or pin provided by the use to the password stored in the user database 140. In an alternative embodiment, usernames and passwords can be stored in a user authentication database that can be accessed by the user authentication module 1260. In an embodiment, the user authentication module can access the user databases 140 or other data stores via the data management module 1120.

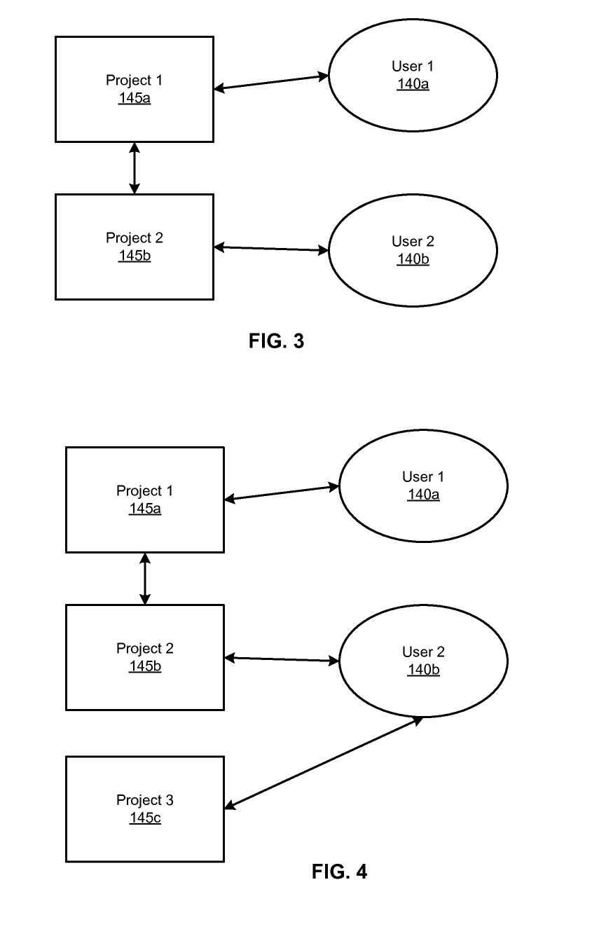

FIGS. 3-7 are block diagrams of data storage areas that can be used with the system illustrated in FIGS. 1 and 2 and logical links between these storage areas according to an embodiment. Each user can be associated with one or more projects and each project can be associated with one more users. For example, FIG. 3 is a block diagram illustrating a set of possible relationships between user databases and project databases according to an embodiment. In FIG. 3, User 1 and User 2 have a vertical relationship. User database 140a is associated with User 1, while user database 140b is associated with User 2. User 1's user database is linked with Project 1's project database 145a, and User 2's user database is linked with Project 2's project database 145b.

Because Project 1 is linked to Project 2, communications between users associated with Project 1 and Project 2 will be copied and stored in both the Project 1 project database 145a and the Project 2 project database 145b. In one example embodiment, User 1 can be a general contractor who creates Project 1—“City Hall Construction” to manage the construction project for a new city hall building. Server 110 can create a user database 140a for User 1, and can create a project database 145a for Project 1. In an embodiment, the user database 140a and the project database 145a are managed by server 110. In some embodiments, the user databases and the project database can be implemented on server 110. In other embodiments, the user database and project database can be implemented on one or more servers in communication with server 110.

The City Hall Construction project might have multiple subcontractors, and each subcontractor can create a user account and create one or more projects databases associated with the project. For example, User 2 can be an electrical subcontractor that is responsible for doing the electrical work on the project. User 2 can request that the server create a project, Project 2—“City Hall Electrical”, and the server can create a user database 140b for User 2 and create a project database 145b for the City Hall Electrical Project.

Through the consensus of both User 1 and User 2, Project 1 and Project 2 can be linked. For example, in one embodiment, User 2 can send a communication request to User 1 to connect Project 1 and Project 2. According to an embodiment, the communication request can be sent as an email message, text message, or other type of message that includes instructions and/or a link that the can be clicked on or otherwise activated by the user to accept the connection. In one embodiment, the system can send an invitation by placing a copy of the invitation in the user database 140 of the invitee (if the invitee is already a user of the system) and when the user logs into the project management system, the user can view and accept or decline the invitation. The system can also be configured to send an email message, text message, or other communication to the user to alert the user to log into the system because a new invitation to link projects has been received.

If User 1 accepts the invitation, the two projects databases can be linked, allowing the system to provide workflow between the two projects and allowing for direct communications between the users. Even if linked, the two databases remain independent in the sense that User 1 cannot delete or modify the content of the Project 2 database and User 2 cannot delete or modify the content of the Project 1 database. Furthermore, copies of all correspondence, documentations, and other information sent between the two users can be maintained in both of the databases.

Alternatively, User 1 can send a request to User 2 to establish a connection between Project 1 and Project 2. Other scenarios are possible. For example, User 2 could send a request for User 1 to link to the Project 2 database directly. In an embodiment, the type of relationship (e.g., vertical or team relationship) can be selected by the user sending the connection request, which determines whether the invitee will be linked directly to the same project database or to a separate project database. More examples illustrating these concepts are provided below.

FIG. 4 is a block diagram illustrating another set of possible relationships between user databases and project databases according to an embodiment. In FIG. 3, User 2 is linked to a third project database 145c. User 2's user database 140b can be linked to both project database 145b and project database 145c, allowing User 2 to access both projects, but the communications, correspondence, documentation, and other information related to each of the projects in the two project database is kept separate. In one example, the third project is related to another construction project “Municipal Library Electrical” that is unrelated to the City Hall Electrical project. The documentation, correspondence, and other information related to the Municipal Library project stored in the project database 145c is kept separate from the content for the City Hall project stored in the project database 145b.

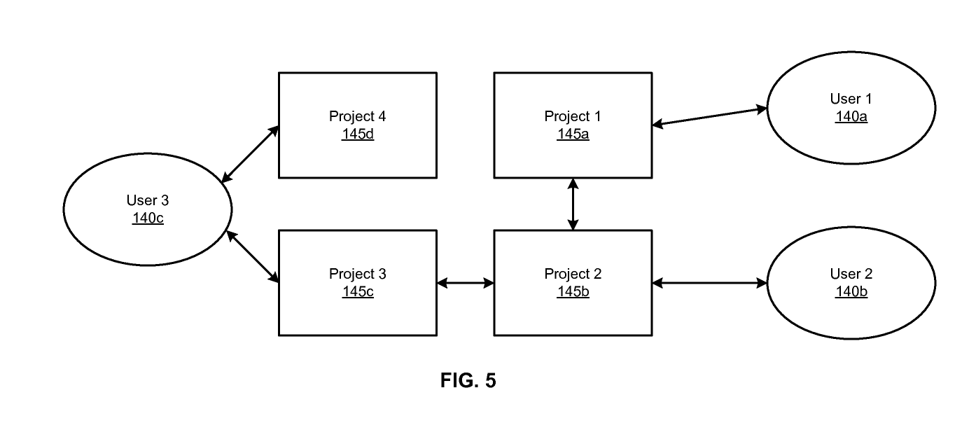

FIG. 5 is a block diagram illustrating yet another set of possible relationships between user databases and project databases according to an embodiment. FIG. 5 illustrates a configuration that is similar to the example illustrated in FIG. 3, except that an additional, User 3, and two projects, Project 3 and Project 4 have been added. User 3 has a user database 140c and User 3's database is linked to project database 145c and to project database 145d. Project 3 is linked to Project 2. Returning now to the City Hall construction example described above, User 3 can be an electrical parts supplier that provides electrical components used by the electrical subcontractor User 2. Project 3 is a “Electrical Deliveries—City Hall” project, while Project 4 is an “Electrical Deliveries—Downtown Mall” project, which is a separate construction project unrelated to the City Hall project for which User 3 is a supplying electrical components. A user can be linked to multiple different types of projects simultaneously. For example, Project 4 could be related to a charity event that User 3's company is sponsoring and for which User 3 is involved in the planning. The system keeps the correspondence and information from Projects 3 and 4 encapsulated in separate database, so that information from Projects 3 and 4 are not commingled. Users 2, who is linked to User 3 through Projects 2 and 3, may not even be aware of Project 4 and would not have access to the contents of the Project 4 database (unless invited to link the project by User 3).

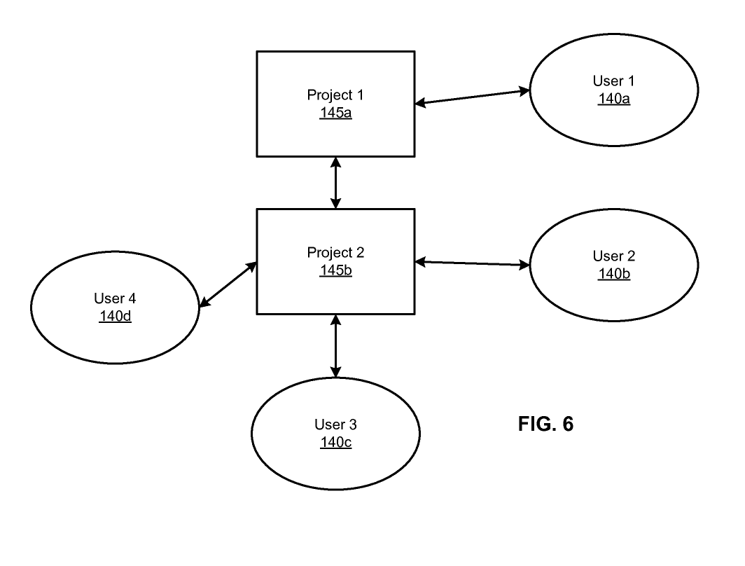

FIG. 6 is a block diagram illustrating another set of possible relationships between user databases and project databases according to an embodiment. FIG. 6 illustrates a configuration that is similar to that of FIG. 3, except that two additional users User 3 and User 4 have been added. User 3 has a user database 140c and User 4 has a user database 140d. User database 140c and user database 140d have also been linked to the project database 145b. Therefore, Users 2, 3, and 4 have a team relationship with respect to Project 2 and can access documentation, communicate, and manage tasks and events within that project. Returning to the previous example described above, if User 2 is an electrical subcontractor, Users 2 and 3 can be electricians that report to User 1 and act on behalf of User 1 to complete tasks related to the installation of the electrical components for the City Hall Electrical project.

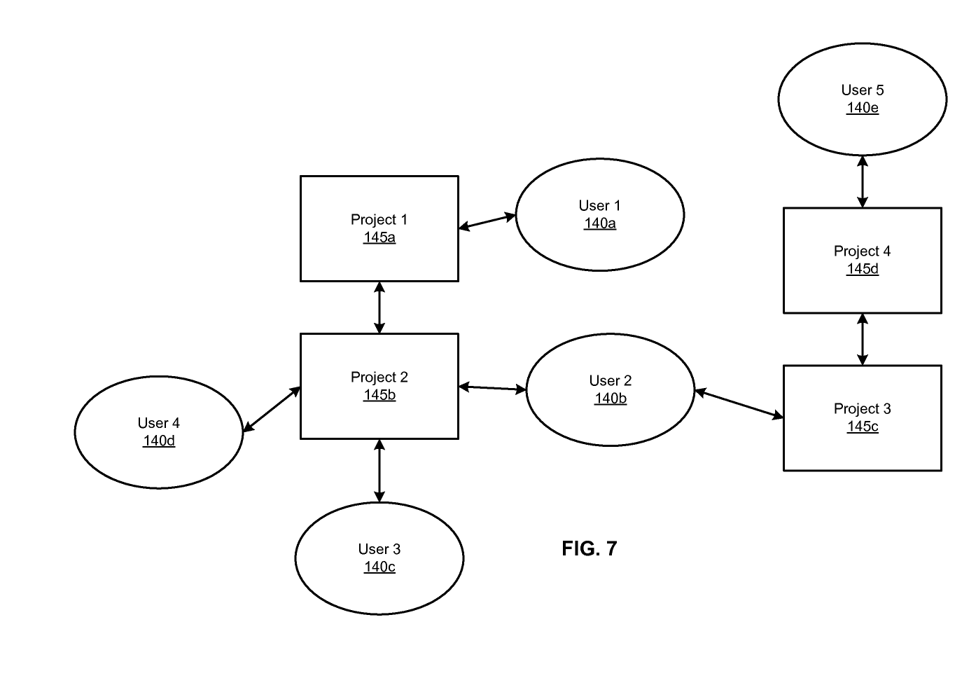

FIG. 7 is a block diagram illustrating another set of possible relationships between user databases and project databases according to an embodiment. FIG. 7 illustrates a configuration that builds on the configuration illustrated in FIG. 6. User 2 is now connected to another project, Project 3. Project 3 has a project database 145c. A fifth user, User 5, has also been added. User 5 has a user database 140e and is associated with a fourth project, Project 4, which has a project database 145d. Projects 3 and 4 have been linked. In some embodiments, the Projects 3 and 4 can be related to Projects 1 and 2. For example, returning once again to the City Hall Project example described above, Project 3 is related to another construction project “Municipal Library Electrical” that is unrelated to the City Hall Electrical project. Project 4 can be a “Municipal Library Construction” project and User 5 can be the general contractor for the project. User 2 and User 5 have established a link between Projects 4 and 5. Therefore, User 2 and User 5 have a vertical relationship. Users 2 and 5 can communicate directly with one another, share documents, and/or other information via the link between Projects 3 and 4.

While User 2 has access to both Project 2 and Project 3 databases, server 110 maintains a separate database for Projects 2 and 3. Communications and/or other information related to Project 2 are kept in the project database 145b and communications and/or other information related to Project 3 are kept in the project database 145c. Thus, Users 3 and 4 who have access to the Project 2 database do not have access to the data in the Project 3 database. However, User 2 could invite Users 3 and 4 to link to the Project 3 database if Users 3 and 4 were to become involved in the Municipal Library Project as well. The server 110 would then establish a link between the User 3 database 140c and the Project 3 project database 145c and a link between the User 4 database 140d and the Project 3 project database 145c.

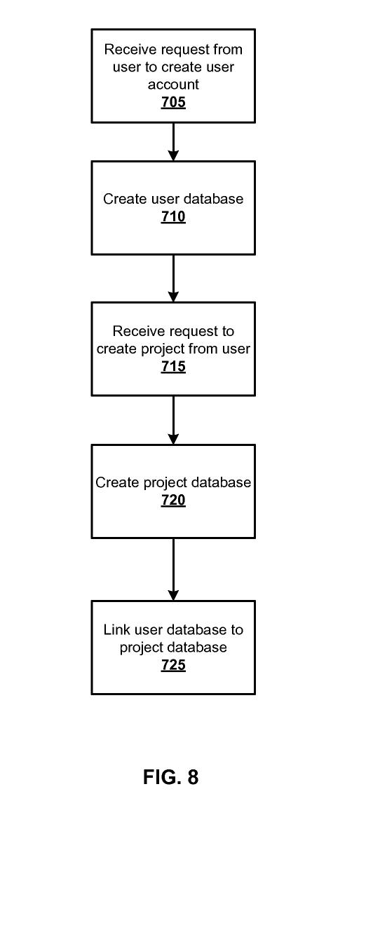

FIG. 8 is a flow diagram of a method for creating a user database and a project database according to an embodiment. The method illustrated in FIG. 8 can be implemented by server 110 of FIGS. 1 and 2 according to an embodiment. The server receives a request to create a user account from a user (step 705). In some embodiments, server 110 can provide a user interface, such as a web page, that is accessible by a user from a user device 120. For example, the server 110 can provide an account creation web page that user can access using browser software on the user device 120. The account creation web page can collect information, such as a username, password, and/or other information about the user that can be used to populate a user database 140 for the user. The server 110 receives the information from the user and creates a new user database (step 710) and populates the database with the information provided by the user. According to an embodiment, the server can user the username and/or password provided by the user to authenticate the user the next time that the user wishes to access a project stored in a project database 245 associated with the user's account or the user's account information stored in the user database 140.

Once the user has created an account, the user can send a request to the server 110 to create a new project. The server 110 can receive this request (step 715) and create a new project database 145 for the project (step 720). The server 110 can then link the user database 140 with the project database 145 (step 725) in order to allow the user to access the content of the project database, to modify content, to create tasks and actions items, draft new communications, and/or other project-related tasks. According to an embodiment, the server 110 can provide a “create new project” user interface, such as a web page, that allows the user to set up a new project. The web page captures the information for the new project, and sends the information to server 110. Server 110 can use this information to set up the new project and to populate the project database 145 for the project with the information provided by the user.

According to an alternative embodiment, the user request the creation of a new account, and the server 110 can create the new user database 140 (step 710), and the user can return later and log into the system to request that the server 110 create a new project.

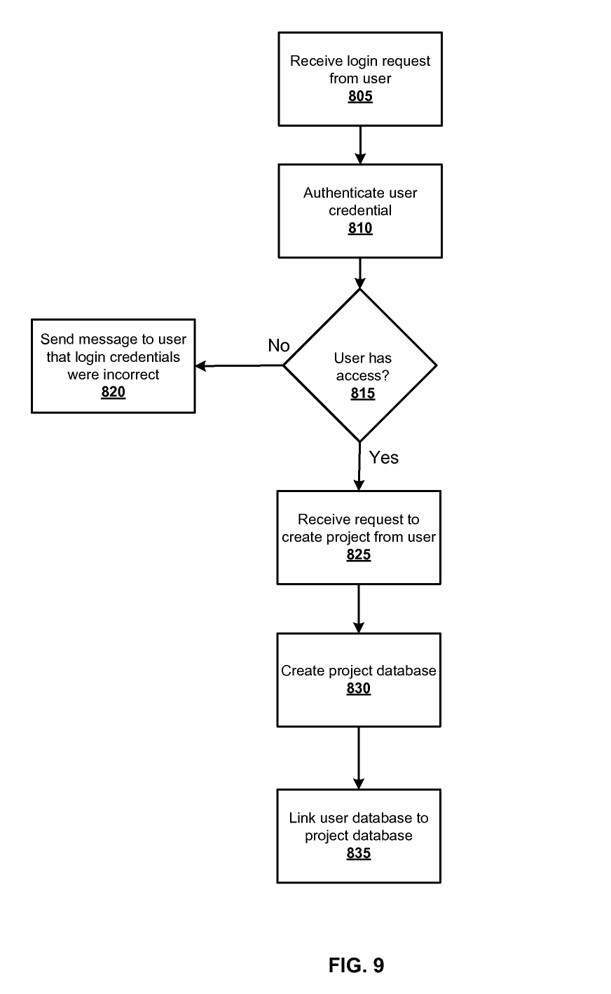

FIG. 9 is a flow diagram of a method for authenticating a user who has an existing account and for creating a new project associated with a user according to an embodiment. The method illustrated in FIG. 9 can be implemented by server 110 illustrated in FIGS. 1 and 2 according to an embodiment.

The server receives a login request from a user (step 805). In an embodiment, the server 110 can provide a user interface, such as a web page, that allows a user to enter user credentials, such as a username and password, that that server 110 can use to authenticate the user in the system. The server 110 authenticates the user using the credentials provided (step 810).

A determination is made whether the user has access based on the credential provided (step 815). If the user did not enter a valid login, the server 110 can send a message to the user's user device 120 indicating that the user did not enter valid credentials. In an embodiment, the server 110 can be configured to provide a user interface for a user to recover lost authentication credentials. For example, the server 110 can send an email message to an email address associated with a user's account that provides instructions for unlocking the user's account, such as requiring the user to click on a link embedded in the message or to enter a temporary password or access code included in the message in order to unlock the user's account. In an alternative embodiment, the server 110 can be configured to send a text message to a mobile number associated with the user's account that includes a link or temporary password that can be used to unlock the user's account.

If the user entered valid credentials, the user can send a request to the server 110 to create a new project. The server 110 can receive the request (step 825) and create a new project database 145 (step 830) for the new project. According to an embodiment, the server 110 can provide a “create new project” user interface, such as a web page, that allows the user to set up a new project. The web page captures the information for the new project, and sends the information to server 110. Server 110 can use this information to set up the new project and to populate the project database 145 for the project with the information provided by the user. Once the project database 145 has been created, the server 110 can then link the user database 140 with the project database 145 (step 835) in order to allow the user to access the content of the project database, to modify content, to create tasks and actions items, draft new communications, and/or other project-related tasks.

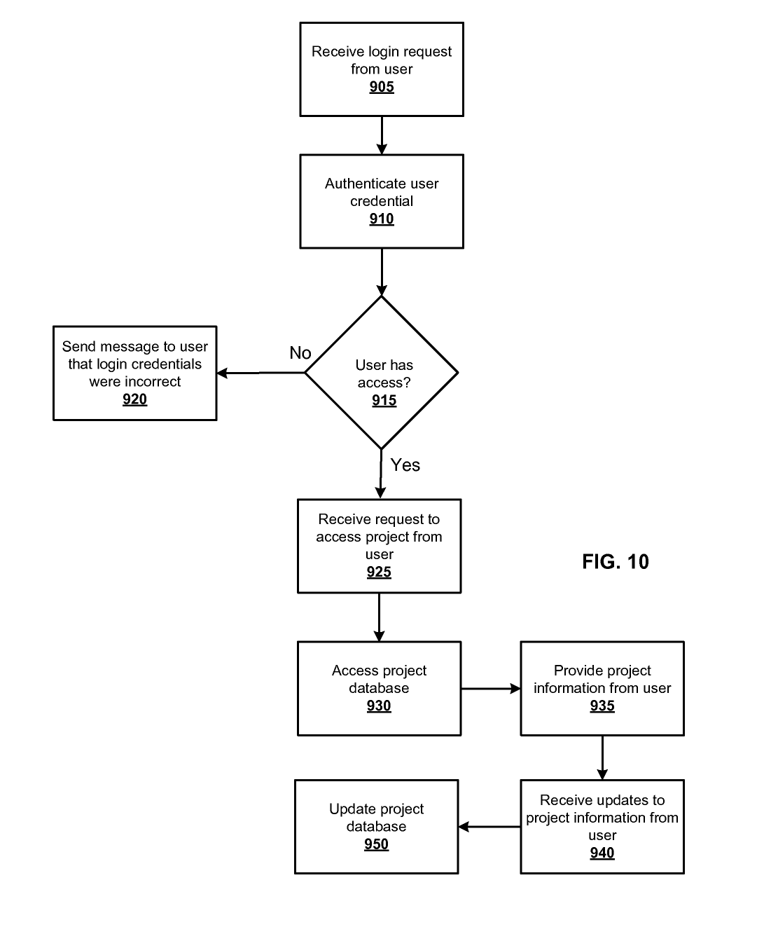

FIG. 10 illustrates a method for authenticating a user to access and update a project according to an embodiment. The method illustrated in FIG. 10 can be implemented by server 110 illustrated in FIGS. 1 and 2 according to an embodiment.

Server 110 receives a login request from a user (step 905). In an embodiment, the server 110 can provide a user interface, such as a web page, that allows a user to enter user credentials, such as a username and password, that that server 110 can use to authenticate the user in the system. The server 110 authenticates the user using the credentials provided (step 910).

A determination is made whether the user has access based on the credential provided (step 915). If the user did not enter a valid login, the server 110 can send a message to the user's user device 120 indicating that the user did not enter valid credentials. In an embodiment, the server 110 can be configured to provide a user interface for a user to recover lost authentication credentials. For example, the server 110 can send an email message to an email address associated with a user's account that provides instructions for unlocking the user's account, such as requiring the user to click on a link embedded in the message or to enter a temporary password or access code included in the message in order to unlock the user's account. In an alternative embodiment, the server 110 can be configured to send a text message to a mobile number associated with the user's account that includes a link or temporary password that can be used to unlock the user's account.

If the user entered valid credentials, the user can send a request to the server 110 to access a project with which the user is associated. The server 110 can receive the request (step 925), access the project database 145 for the selected project (step 930), and provide the project information to the user (step 935). According to an embodiment, the server 110 can be configured to provide a user interface, such as a web page, that includes a list of projects with which the user is associated. This user interface can be displayed to the user after the server has authenticated the user's credentials. According to an embodiment, the user can select one of the projects with which the user is associated, and the server 110 can load the project information and display a project “dashboard” user interface that display information related to the project and a set of controls for adding information to the project (e.g., drafting a new communication, responding to a communication, drafting or uploading documentation), modifying existing project content, or deleting information from the project. In an embodiment, the dashboard interface can be configured to display incoming communications send to the user, action items that require attention of the user, and/or other information. The dashboard interface can also include an interface for tracking the progress of communications through the system. For example, if a communication requires the approval of multiple parties, the user interface can provide a list of where the communication is along the workflow, including which users have already processed the communication, which users still have to process the communication, and which user or users currently have the communication in their inbox.

At step 935, the server 110 can receive updates to the project information from the user (step 940). The server 110 can then update the project database with the updated information (step 950). According to an embodiment, the dashboard interface can be configured to automatically send updates to the server 110 when the user makes a change to the project information using the dashboard interface.

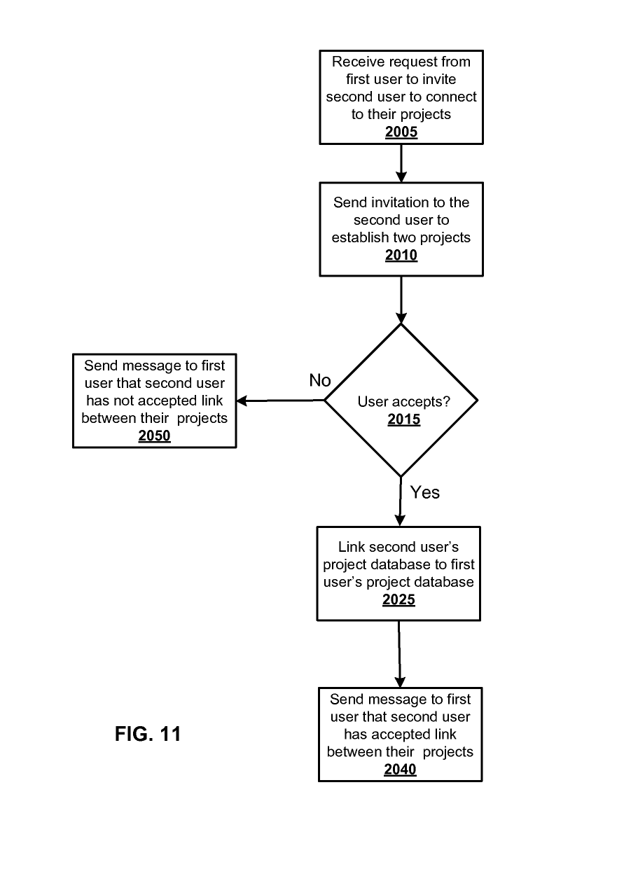

FIG. 11 is a flow diagram of a method for sending an invitation from a first user to a second user to establish a link between the first user's project database and the second user's project database according to an embodiment. The method illustrated in FIG. 11 can be implemented by the server 110 illustrated in FIGS. 1 and 2. The server 110 receives a request from a user to send a communication to a second user to establish a connection link between their project databases (step 2005). According to an embodiment, the dashboard interface described above can include tools that allow a user to send an invitation to another user to connect, or link, to a project. For example, in one embodiment, the dashboard interface can be configured to allow a first user to enter the username of a second user that the first user would like to invite to connect to a project. According to an embodiment, the dashboard interface can include controls that allow the user select which project that the first user would like to invite the second user to connect to.

According to an embodiment, the dashboard interface can be configured to allow the first user to select the type of relationship that should be created. This type of invitation would typically be used where the first user and the second user have a vertical relationship where one party provides approval, direction, and final acceptance, while the other party provides products and services. The invited user can then be linked to a separate project database and the invited user's project database can then be linked back to the project database selected by the first user. If the second user accepts the invitation from the first user, the server 110 can automatically create a link for the invited user's project database to the project database selected by the first user.

The server 110 can send an invitation to the second user as requested by the first user (step 2010). According to an embodiment, the server 110 can send a message, such as an email message, text message, or other type of message, to the client device 120 of the second user inviting the second user to create a link with the first user. In an alternative embodiment, the server 120 can generate a communication inviting the second user to link to the first user and place the communication in the user database 140 of the second user. The second user can then access the communication the next time that the second user logs into the project management system, of if the second user is already logged into the system, the server 110 can be configured to display the communication from the first user on the dashboard interface of the second user.

The server 110 can then make a determination whether the second user has accepted the invitation of the first user (step 2015). According to an embodiment, the second user can expressly accept the invitation of the first user, such as a by clicking a link in the communication or by sending a response to the communication. In an embodiment, the second user can also expressly decline the invitation by clicking on a link included in the invitation or by sending a response to the invitation to the first user.

If the second user does not accept the invitation, server 110 can send a message to the first user that the second user has not accepted the invitation (step 2050). In some embodiments, the second user can expressly reject the invitation by clicking a link in the communication. In other embodiments, if the second user fails to respond to the invitation within a predetermined period of time, the server 110 can set the invitation to an expired state where the invitation can no longer be accepted by the second user and send a notification that to the first user that the second user failed to respond to the invitation within the predetermined time period associated with the invitation.

If the second user accepts the invitation, server 110 can link the second user to the first user according to the type of connection to be established (step 2025). For example, if the second user already had created or was associated with an existing project database 145 related to the project, or created a new one, for which the first user send the communication in step 1010, the server 110 can link the existing project database 145 to the project database 145 of the project selected by the first user in step 1010.

The server 110 can also send a message to the first user that the second user has accepted the invitation (step 2040) and a link between the projects has been established. In some embodiments, the server 110 can also be configured to send a confirmation to both the first user and the second user that the connection has established.

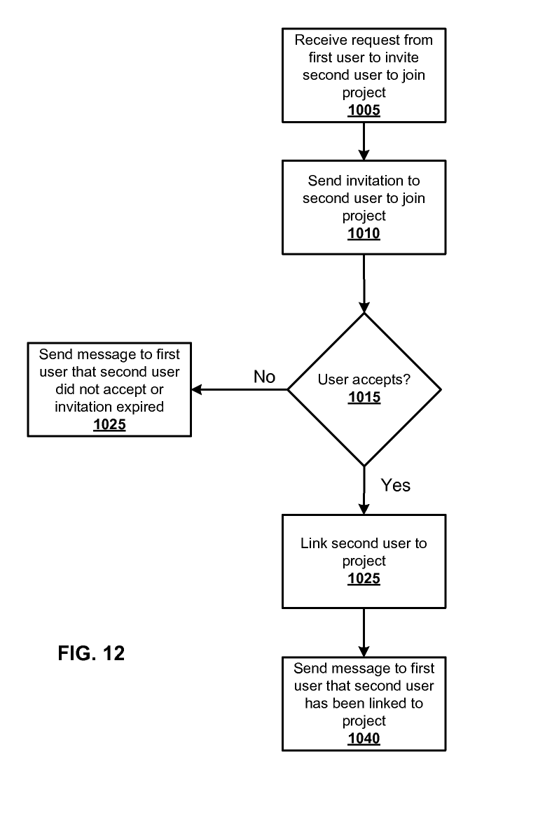

FIG. 12 is a flow diagram of a method for sending an invitation from a first user to a second user to establish a link between the first user and the second user according to an embodiment. The method illustrated in FIG. 12 can be implemented by the server 110 illustrated in FIGS. 1 and 2. The server 110 receives a request from a user to send a communication to a second user to join a project or connect to the same project database (step 1005). According to an embodiment, the dashboard interface described above can include tools that allow a user to send an invitation to another user to join a project. For example, in one embodiment, the dashboard interface can be configured to allow a first user to enter the username of a second user that the first user would like to invite to join a project. According to an embodiment, the dashboard interface can include controls that allow the user select which project that the first user would like to invite the second user to join.

According to an embodiment, the dashboard interface can be configured to allow the first user to select the type of relationship in which the invited user will be linked to the same project database to which the first user is linked if the second user accepts the invitation. This type of invitation would typically be used where the first user and the second user should log into the same project and will communicate and manage tasks in that project. For example, if the first user is a project manager and the second user is a project team member, establishing a team relationship between the first user and the second user may be appropriate. The server 110 can send an invitation to the second user as requested by the first user (step 1010). According to an embodiment, the server 110 can send a message, such as an email message, text message, or other type of message, to the client device 120 of the second user inviting the second user to create a link with the first user. In an alternative embodiment, the server 120 can generate a communication inviting the second user to link to the first user and place the communication in the user database 140 of the second user. The second user can then access the communication the next time that the second user logs into the project management system, of if the second user is already logged into the system, the server 110 can be configured to display the communication from the first user on the dashboard interface of the second user.

The server 110 can then make a determination whether the second user has accepted the invitation of the first user (step 1015). According to an embodiment, the second user can expressly accept the invitation of the first user, such as a by clicking a link in the communication or by sending a response to the communication. In an embodiment, the second user can also expressly decline the invitation by clicking on a link included in the invitation or by sending a response to the invitation to the first user. According to another embodiment, server 110 can also be configured to wait a predetermined amount of time before the invitation expires or times out. For example, in one embodiment, the server 110 can be configured so that invitations expire if the second user does not respond to the invitation within one week. According to other embodiments, other expiration periods can be set. In yet other embodiments, the first user can select a time that the invitation will expire when creating the invitation.

If the second user declines the invitation or the invitation expires without receiving a response from the second user, the server 110 can send a message to the first user indicating that the second user declined the invitation or that the invitation has expired (step 1025). The server 110 can insert the message in to the user database 140 of the first user. According to an embodiment, the message can be displayed on the user device 120 of the first user.

Otherwise, if the second user accepts the invitation, server 110 can link the second user to the project database. For example, the server 110 can link the user database 140 of the second user to the project database 145 of the project selected by first user in step

The server 110 can also send a message to the first user that the second user has accepted the invitation (step 1040) and a link between the users and/or projects has been established. In some embodiments, the server 110 can also be configured to send a confirmation to both the first user and the second user that the connection has established.

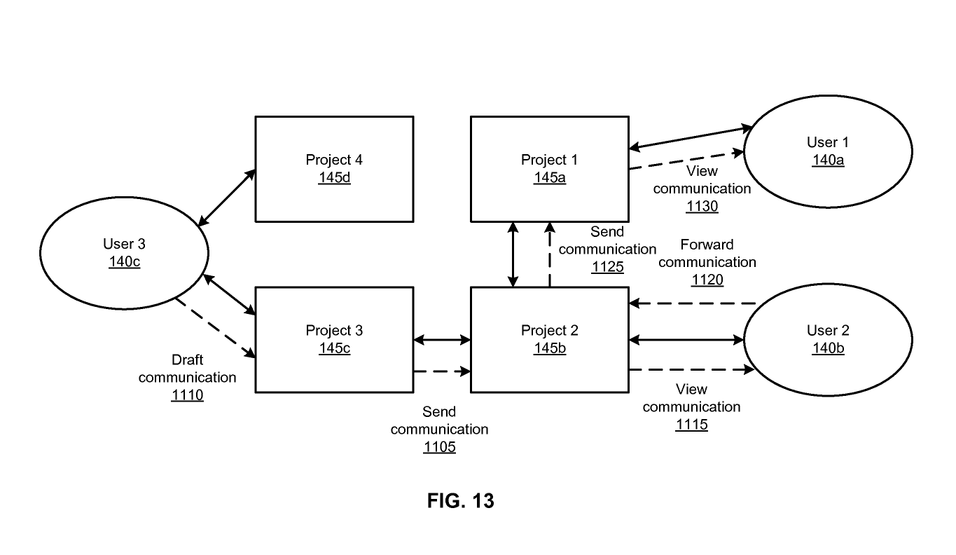

FIG. 13 is block diagram illustrating a method for indirectly sending a communication from a first user to a second user via an intermediate third user according to an embodiment. FIG. 13 illustrates a possible set of relationships between users and projects similar to that illustrated in FIG. 4 according to an embodiment. One skilled in the art will recognize that the method illustrated in FIG. 13 can be used for indirect communication between users in other configurations as well. The method illustrated in FIG. 13 can be implemented by the server 110 illustrated in FIGS. 1 and 2 in an embodiment.

In the embodiment illustrated in FIG. 13, User 1 is linked to Project 1, User 2 is linked to Project 2, and User 3 is linked to Projects 3 and 4. User 1 is linked to User 2 through the link between Project 1 and Project 2, and User 2 is linked to User 3 through the link between Project 2 and Project 3.

FIG. 13 illustrates one of the benefits that the systems and methods disclosed herein can provide over conventional systems—the systems and methods disclosed herein facilitate communication between the various parties associated with a project. The server 110 can be configured to track and monitor the progress and status of each issue. As an example, returning the City Hall Example described in FIG. 5, User 3 is an electrical parts supplier that provides electrical components used by the electrical subcontractor User 2. User 3 can send a question or action item to User 2 related to an electrical component to be used in the City Hall construction project. If User 2 does not know the answer to the question, User 2 can forward the question on to the User 1, the general contractor for the City Hall construction project. User 3 is not linked to User 1, and thus, cannot directly communicate with User 1, the general contractor for the City Hall project. However, User 3 can indirectly communicate with User 1 through the connections to User 2.

FIG. 13 illustrates the steps taken in a scenario where a communication is forwarded from one user to another user. User 3 can draft a communication asking User 2 requesting information about a specific electrical component to be used in the construction of the City Hall project (step 1110), and the project database 145c for Project 3 will be updated to include a copy of the communication. Project 2 is linked to Project 3, and the project database 145b of Project 2 can be updated to include a copy of the communication (step 1105). User 2, whose database 140b is linked to the project database 145b, can view the communication on User 2's user device 120. In one example, the incoming communication from User 3 can be displayed on the project dashboard for User 2. User 2, the electrical contractor, can then choose to respond to the communication or to forward the communication on to User 1, the general contractor, to get User 1's feedback (step 1120). The system can update project database 145a, the Project 1, which is linked to the Project 2 database (step 1125). The server 110 can update the Project 1 database 145a to include a copy of the communication, and user 1, whose user database 140a is linked to Project 1's project database 145a can view the communication (step 1130). User 1 can respond to the communication, and the project databases 145a, 145b, and 145c can be updated to include the response from User 1. In some embodiments, User 1 can privately respond to User 2 and User 3 will not receive User 1's response. In this embodiment, the project databases 145a and 145 would include the response from User 1 to User 2, but the project database 145c would not include the response from User 1 to User 2. In an embodiment, User 2 could forward the response from User 1 to User 3, and the project database 145c would be updated to include the forwarded response.

According to an embodiment, the system can provide a communication log that allows users to track the status of each communication that the parties have sent or received. For example, in the example illustrated in FIG. 13, User 3 could access the communication log to determine whether User 2 has read the communication that User 1 sent to User 2. The communication log can also notify User 3 that the User 2 has forwarded the communication to User 3 to obtain additional information, and whether User 3 has read or responded to User 2. According to an embodiment, the server 110 can include a workflow module that can be configured to track the path that a communication has taken through the system and to provide the status of the communication to users that are included along the communication chain.

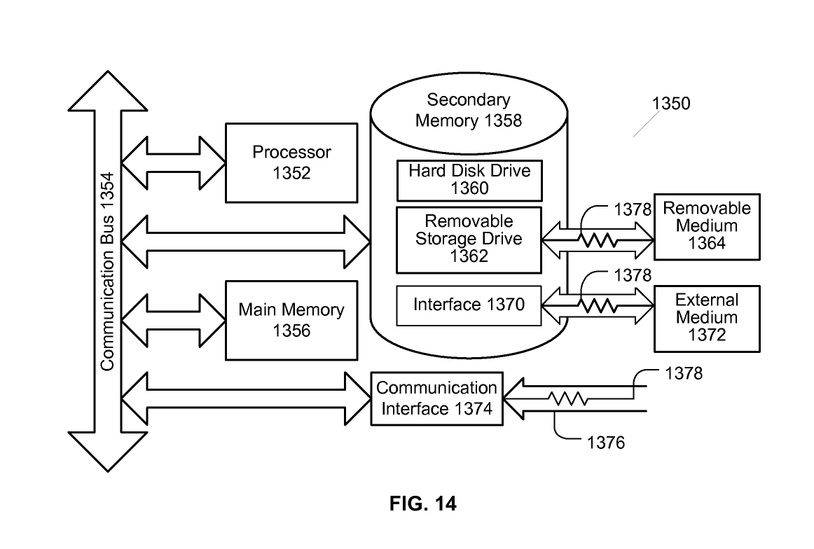

FIG. 14 is a block diagram illustrates an embodiment of an exemplary computer system 1350 that may be used in connection with various embodiments described herein. For example, the computer system 1350 may be used to implement the user devices 120a-120e illustrated in FIG. 1 and can be used to implement server 110 illustrated in FIGS. 1 and 2. However, other computer systems and/or architectures may be used, as will be clear to those skilled in the art.

The computer system 1350 preferably includes one or more processors, such as processor 1352. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 1352.

The processor 1352 is preferably connected to a communication bus 1354. The communication bus 1354 may include a data channel for facilitating information transfer between storage and other peripheral components of the computer system 1350. The communication bus 1354 further may provide a set of signals used for communication with the processor 1352, including a data bus, address bus, and control bus (not shown). The communication bus 1354 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 1350 preferably includes a main memory 1356 and may also include a secondary memory 1358. The main memory 1356 provides storage of instructions and data for programs executing on the processor 1352. The main memory 1356 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 1358 may optionally include a hard disk drive 1360 and/or a removable storage drive 1362, for example a floppy disk drive, a magnetic tape drive, a compact disc (“CD”) drive, a digital versatile disc (“DVD”) drive, etc. The removable storage drive 1362 reads from and/or writes to a removable storage medium 1364 in a well-known manner. Removable storage medium 1364 may be, for example, a floppy disk, magnetic tape, CD, DVD, etc.

The removable storage medium 1364 is preferably a non-transitory computer readable medium having stored thereon computer executable code (i.e., software) and/or data. The computer software or data stored on the removable storage medium 1364 is read into the computer system 1350 as electrical communication signals 1378.

In alternative embodiments, secondary memory 1358 may include other similar means for allowing computer programs or other data or instructions to be loaded into the computer system 1350. Such means may include, for example, an external storage medium 1372 and an interface 1370. Examples of external storage medium 1372 may include an external hard disk drive or an external optical drive, or and external magneto-optical drive.

Other examples of secondary memory 1358 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 1372 and interfaces 1370, which allow software and data to be transferred from the removable storage unit 1372 to the computer system 1350.

Computer system 1350 may also include a communication interface 1374. The communication interface 1374 allows software and data to be transferred between computer system 1350 and external devices (e.g. printers), networks, or information sources. For example, computer software or executable code may be transferred to computer system 1350 from a network server via communication interface 1374. Examples of communication interface 1374 include a modem, a network interface card (“NIC”), a communications port, a PCMCIA slot and card, an infrared interface, and an IEEE 1394 fire-wire, just to name a few.

Communication interface 1374 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 1374 are generally in the form of electrical communication signals 1378. These signals 1378 are preferably provided to communication interface 1374 via a communication channel 1376. Communication channel 1376 carries signals 1378 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 1356 and/or the secondary memory 1358. Computer programs can also be received via communication interface 1374 and stored in the main memory 1356 and/or the secondary memory 1358. Such computer programs, when executed, enable the computer system 1350 to perform the various functions of the present invention as previously described.

In this description, the term “computer readable medium” is used to refer to any non-transitory computer readable storage media used to provide computer executable code (e.g., software and computer programs) to the computer system 1350. Examples of these media include main memory 1356, secondary memory 1358 (including hard disk drive 1360, removable storage medium 1364, and external storage medium 1372), and any peripheral device communicatively coupled with communication interface 1374 (including a network information server or other network device). These computer readable mediums are means for providing executable code, programming instructions, and software to the computer system 1350.

In an embodiment that is implemented using software, the software may be stored on a computer readable medium and loaded into computer system 1350 by way of removable storage drive 1362, interface 1370, or communication interface 1374. In such an embodiment, the software is loaded into the computer system 1350 in the form of electrical communication signals 1378. The software, when executed by the processor 1352, preferably causes the processor 1352 to perform the inventive features and functions previously described herein.

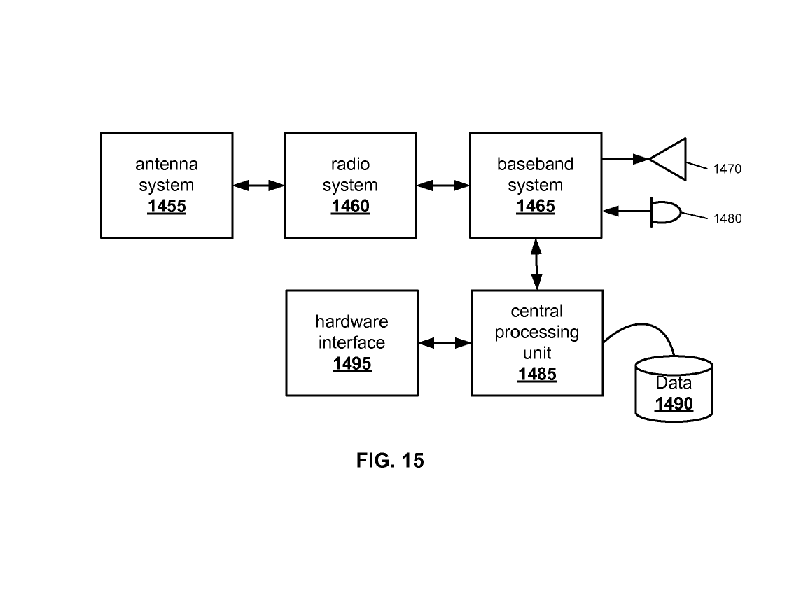

FIG. 15 is a block diagram illustrating an embodiment of an exemplary wireless communication device 1450 that may be used in connection with various embodiments described herein. For example, the wireless communication device 1450 may be used to implement user device 120 or server 110 as previously described with respect to FIG. 1. However, other wireless communication devices and/or architectures may also be used, as will be clear to those skilled in the art.

In the illustrated embodiment, wireless communication device 1450 comprises an antenna system 14555, a radio system 1460, a baseband system 1465, a speaker 1470, a microphone 1480, a central processing unit (“CPU”) 1485, a data storage area 1490, and a hardware interface 1495. In the wireless communication device 1450, radio frequency (“RF”) signals are transmitted and received over the air by the antenna system 1455 under the management of the radio system 1460.

In one embodiment, the antenna system 1455 may comprise one or more antennae and one or more multiplexors (not shown) that perform a switching function to provide the antenna system 1455 with transmit and receive signal paths. In the receive path, received RF signals can be coupled from a multiplexor to a low noise amplifier (not shown) that amplifies the received RF signal and sends the amplified signal to the radio system 1460.

In alternative embodiments, the radio system 1460 may comprise one or more radios that are configured to communication over various frequencies. In one embodiment, the radio system 1460 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 560 to the baseband system 1465.

If the received signal contains audio information, then baseband system 1465 decodes the signal and converts it to an analog signal. Then the signal is amplified and sent to the speaker 1470. The baseband system 1465 also receives analog audio signals from the microphone 1480. These analog audio signals are converted to digital signals and encoded by the baseband system 1465. The baseband system 1465 also codes the digital signals for transmission and generates a baseband transmit audio signal that is routed to the modulator portion of the radio system 1460. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 1455 where the signal is switched to the antenna port for transmission.

The baseband system 1465 is also communicatively coupled with the central processing unit 1485. The central processing unit 1485 has access to a data storage area 1490. The central processing unit 1485 is preferably configured to execute instructions (i.e., computer programs or software) that can be stored in the data storage area 1490. Computer programs can also be received from the baseband processor 1465 and stored in the data storage area 1490 or executed upon receipt. Such computer programs, when executed, enable the wireless communication device 1450 to perform the various functions of the present invention as previously described. For example, data storage area 1490 may include various software modules (not shown) such as those modules previously described with respect to FIG. 2.

In this description, the term “computer readable medium” is used to refer to any media used to provide executable instructions (e.g., software and computer programs) to the wireless communication device 1450 for execution by the central processing unit 1485. Examples of these media include the data storage area 1490, microphone 1480 (via the baseband system 1465), antenna system 1455 (also via the baseband system 1465), and hardware interface 1495. These computer readable mediums are means for providing executable code, programming instructions, and software to the wireless communication device 1450. The executable code, programming instructions, and software, when executed by the central processing unit 1485, preferably cause the central processing unit 1485 to perform the inventive features and functions previously described herein.

The central processing unit 1485 is also preferably configured to receive notifications from the hardware interface 1495 when new devices are detected by the hardware interface. Hardware interface 1495 can be a combination electromechanical detector with controlling software that communicates with the CPU 1485 and interacts with new devices. The hardware interface 1495 may be a firewire port, a USB port, a Bluetooth or infrared wireless unit, or any of a variety of wired or wireless access mechanisms. Examples of hardware that may be linked with the device 1450 include data storage devices, computing devices, headphones, microphones, and the like.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A technical system for managing projects, the system comprising:
a non-transitory computer readable medium for storing computer executable programmed modules;
a processor communicatively coupled with the computer readable medium for executing programmed modules stored therein;
a workflow module stored in the non-transitory computer readable medium and configured to manage a plurality of user databases and project databases;
create links between the user databases and the project databases, wherein if a user database is linked to a project database, a user associated with the project database can access content in the project database;
create links between project databases; and
manage communications between projects based on workflow rules, wherein copies of communications between users associated with each of the projects are copied to each linked project database where communications are drafted between users linked to different project databases.

2. The system of claim 1, further comprising:
a user authentication module in communication with the workflow module, the user authentication module being configured to receive a first set of login credentials provided by a user and to authenticate the credentials using a second set of login credential stored on the system.

3. The system of claim 2 wherein the second set of login credentials are stored in a user database associated with a username associated with the login credentials.

4. The system of claim 2 wherein the second set of login credentials are stored in an authorization database and are associated with a username.

5. The system of claim 1, further comprising a network interface module in communication with the workflow module, the network interface module providing an interface for receiving data across a network from one or more client devices and for sending data across the network to the one or more client device.

6. The system of claim 5 wherein the network interface module is configured to format data received from the network into a format expected by one or more other modules, and wherein the network interface module is further configured to format the data received from the one or more other modules into a format that can be transmitted across the network.

7. The system of claim 5 further comprising a data management module in communication with the workflow module, wherein the data management module is configured to write data to and access data from the user databases and the project databases.

8. The system of claim 5 wherein the data management module is configured to convert requests for data received from one or more modules of the system into a query that can be processed by the user databases and the project databases.

9. The system of claim 1, further comprising a communications module in communication with the workflow module, the being configured to allow a user draft communications to be sent to one or more other users.

10. The system of claim 9 wherein the communications module is configured to allow a user to select one or more workflow rules to be associated with a communication, and wherein the workflow module is configured to route the communication through the system using the one or more workflow rules.

11. The system of claim 9, wherein the communications module is configured to allow a first user to send an invitation to a second user to link the second user to a project database to which the first user is linked, and wherein the workflow module is configured to create the link of the second user accepts the invitation.

12. The system of claim 11 wherein the invitation includes a relationship type, and wherein the workflow module is configured to establish links based on the relationship type.

13. The system of claim 12, wherein the workflow module is configured to establish a link between the user database of the second user and a first project database to which the first user is linked if the invitation indicates that the relationship is a team relationship type.

14. The system of claim 12, wherein if the relationship type indicated in the invitation is a vertical relationship type, the workflow module is configured to:
send an invitation to the second user to link to a second project database created by the second user to the first project database created by the first user;
linking the first project database of the first user to the second project database of the second user upon acceptance of the invitation, wherein linking the first database to the second database includes workflow rules for communication between the first and second projects, and wherein once the first project database is linked to the second project database, the first user and the second user can communicate through the linked project databases.

15. The system of claim 1, further comprising a user interface module, the user interface module being configured to provide a user interface for a user to interact with the system from a user device over a network connection.

16. The system of claim 13 wherein the user interface module is configured to generate one or more web pages with which the user can interact using a browser software application being executed on the user device.

17. The system of claim 1 wherein if a user database is linked to a project database, a user associated with the project database can access content in the database based on an authorization level associated with the user and the project database.

18. A computer implemented method for managing projects, where one or more processors are programmed to perform steps comprising:
receiving a request from a first user to send an invitation to a second user to link the second user with a first project having a first project database;
sending the invitation to the second user;
receiving a response from the second user indicating whether the second user accepts the invitation; and
creating a link between the second user and the first project database if the second user accepts the invitation, wherein the link allows the second user to access content in the first project database.

19. The method of claim 18 wherein the invitation includes a relationship type, and wherein creating a link to the second user if the user accepts the invitation further comprises creating one or more links based on the relationship type.

20. The method of claim 19, further comprising:
linking the first user database of the second user and a first project database to which the first user is linked if the invitation indicates that the relationship is a team relationship type.

21. The method of claim 19, wherein if the relationship type indicated in the invitation is a vertical relationship type, performing the following:
sending an invitation to the second user to link to a second project database created by the second user to the first project database created by the first user;
linking the first project database of the first user to the second project database of the second user upon acceptance of the invitation, wherein linking the first database to the second database includes workflow rules for communication between the first and second projects, and wherein once the first project database is linked to the second project database, the first user and the second user can communicate through the linked project databases.

22. The method of claim 18, further comprising:
receiving a request from the first user to send a communication to one or more users; and
routing the communication to one or more users based on a workflow rules associated with the communication.

23. The method of claim 22 wherein the workflow rules associated with the communication are specified by the users.
